(19) United States
(12) Patent Application Publication
(10) Pub. No.: US 2025/0070675 A1
(43) Pub. Date: Feb. 27, 2025

(54) POWER CONVERTER CONTROL CIRCUIT AND METHOD

(71) Applicant: REDISEM LTD., Hong Kong (CN)

(72) Inventors: Russell JACQUES, Hong Kong (CN); David COULSON, Hong Kong (CN); Niek VAN DER DUIJN SCHOUTEN, Hong Kong (CN)

(73) Assignee: REDISEM LTD., Hong Kong (CN)

(21) Appl. No.: 18/728,164

(22) PCT Filed: Jan. 27, 2022
(86) PCT No.: PCT/CN2022/074423

§ 371 Date: Jul. 11, 2024

(51) Int. Cl. H02M 3/335; H02M 1/00; H02M 1/32; H02M 1/36; H02M 1/42; H02M 3/00; H02M 3/07

(52) U.S. Cl. CPC H02M 3/33507; H02M 1/0009; H02M 1/325; H02M 1/36; H02M 1/4266; H02M 3/01; H02M 3/07

(57) ABSTRACT

A control circuit for a power converter. The power converter comprises a primary circuit for receiving a supply power, with the primary circuit having a primary connection. A secondary circuit provides a load power to a load. The secondary circuit has a secondary connection connected to the primary connection. There is a current sensing circuit for detecting a current sense signal derived from an output current, and a voltage sensing circuit for detecting a voltage sense signal derived from an output voltage. The control circuit comprises a controller for controlling one or more switches in the primary circuit to control the output current and/or the output voltage in accordance with one or more control profiles and based on the current sense signal and/or the voltage sense signal.

### TECHNICAL FIELD

The invention relates to controllers for power converters, power converters, and methods of converting power and of controlling power conversion. The invention has been described for use with light emitting diode (LED) drivers and power supplies, but the invention is not limited to these particular applications.

### BACKGROUND ART

Many applications, particularly those involving LED lighting, require a power converter which employs power factor correction on the line input and constant voltage (CV) and constant current (CC) on the output. Some offline power converter applications, such as power adapters and LED drivers, require a short-term high-current startup for pulling up loads such as high capacitance, constant current, and constant power.

In most countries, power factor correction (PFC) is a requirement for offline converters which have power ratings above specified limits. The PFC feature can be provided using one of two methods, either active power factor correction (APFC) or passive power factor correction (PPFC). The APFC method is provided by a standalone AC-DC converter, employing a high voltage switching device, an integrated controller and passive components. APFC is capable of providing high power factor and low harmonic emissions across a wide range of inputs and load ranges. By comparison, the PPFC circuit has some limitations, but is much simpler, smaller, and lower cost. Prior PPFC methods are described in W02015/143612A1 and W02018/137240A1.

The charge pump PPFC method has a drawback in that the bulk capacitor can be charged to a high voltage when the converter output current is raised significantly or if the output voltage reduces significantly. This is undesirable because it increases the cost and complexity of the converter. Additionally, this overboosting effect is magnified if certain fault conditions are present, for example, in a short circuit. Overboosting can also occur with a high capacitance load or a constant power load such as a DC-DC converter, both of which can resemble an overload.

One prior method of protection stops the power converter if an overload fault is detected in the first few milliseconds of operation, so that the bulk voltage only rises slightly. However, if the product has a high current startup and automatic recovery, the controller must repeatedly try to restart every few seconds, which causes the bulk voltage to increment on each attempt. One method to mitigate this is to provide bleed resistance across the bulk capacitor, but this can cause significant power loss, increase complexity while degrading the efficiency of the power converter. There is, therefore, a need for a safe and low-cost method of removing the excess charge from the bulk capacitor so that the PPFC method can be used advantageously. Removing charge from non-charge pump PFC systems is not necessary because the bulk capacitor is not overcharged.

Similarly, for APFC and no-PFC systems, a high output current for lengthy periods of time can cause significant stress for the converter, particularly in fault conditions. It would therefore be prudent to use a method of limiting the stress while allowing for repeated re-start attempts.

It is an object of the present invention to overcome or ameliorate at least one of the disadvantages of the prior art, or to provide a useful alternative.

### SUMMARY OF INVENTION

### Technical Problem

### Solution to Problem

### Technical Solution

Embodiments of the present invention in a first aspect provide a control circuit for a power converter, the power converter comprising:
a primary circuit for receiving a supply power, the primary circuit having a primary connection;
a secondary circuit for providing a load power to a load, the secondary circuit having a secondary connection connected to the primary connection;
a current sensing circuit for detecting a current sense signal derived from an output current; and
a voltage sensing circuit for detecting a voltage sense signal derived from an output voltage;
the control circuit comprising a controller for controlling one or more switches in the primary circuit to control the output current and/or the output voltage in accordance with one or more control profiles and based on the current sense signal and/or the voltage sense signal.

Embodiments of the present invention in a second aspect provide a power converter having a control circuit as described above.

Embodiments of the present invention in a third aspect provide a LED lighting apparatus having a control circuit as described above.

Embodiments of the present invention in a fourth aspect provide a method of controlling a power converter, the power converter comprising:
a primary circuit for receiving a supply power, the primary circuit having a primary connection; and
a secondary circuit for providing a load power to a load, the secondary circuit having a secondary connection connected to the primary connection;
the method comprising:
detecting a current sense signal derived from an output current;
detecting a voltage sense signal derived from an output voltage; and

controlling one or more switches in the primary circuit to control the output current and/or the output voltage in accordance with one or more control profiles and based on the current sense signal and/or the voltage sense signal.

Other features and embodiments of the present invention can be found in the appended claims.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### Advantageous Effects of Invention

### BRIEF DESCRIPTION OF DRAWINGS

### Description of Drawings

The accompanying figures include the following figures depicting the prior art:

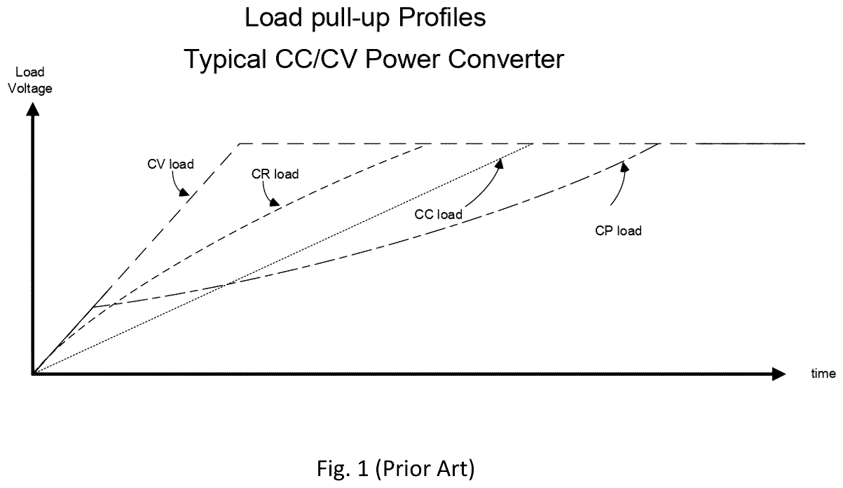

FIG. 1 is a graph showing plots of the voltage profiles of a prior CC/CV power converter pulling up a variety of loads.

Preferred embodiments in accordance with the best mode of the present invention will now be described, by way of example only, with reference to the accompanying figures listed below, in which the same reference numerals, names, or other reference labels refer to like parts throughout the figures listed below unless otherwise specified, and in which;

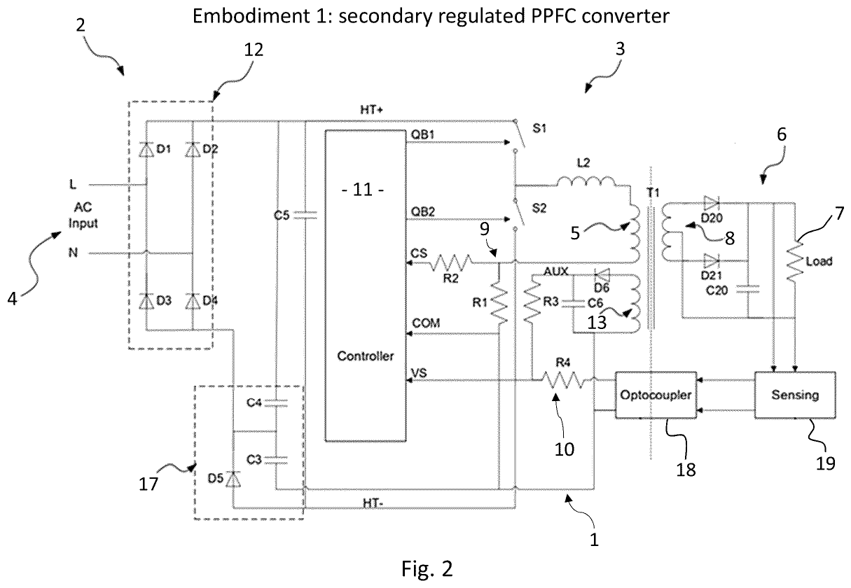

FIG. 2 is a schematic diagram of a power converter in accordance with an embodiment of the present invention;

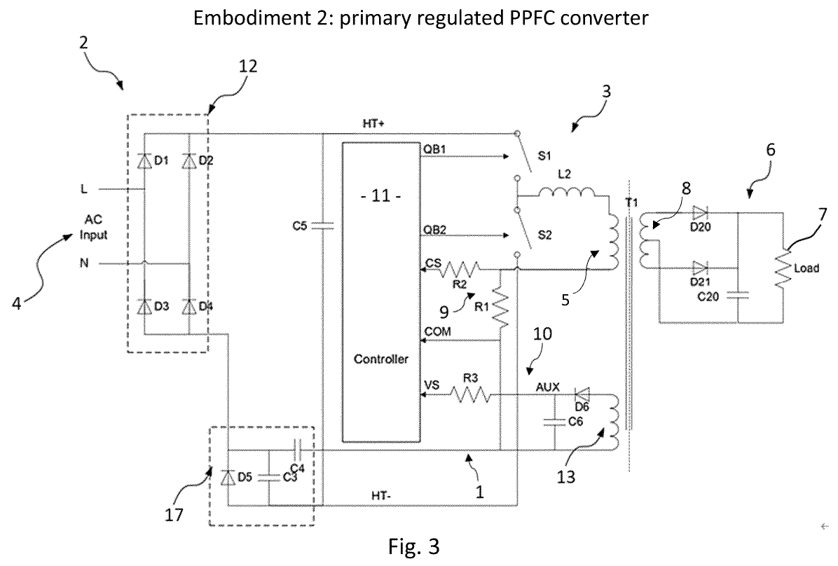

FIG. 3 is a schematic diagram of a power converter in accordance with another embodiment of the present invention;

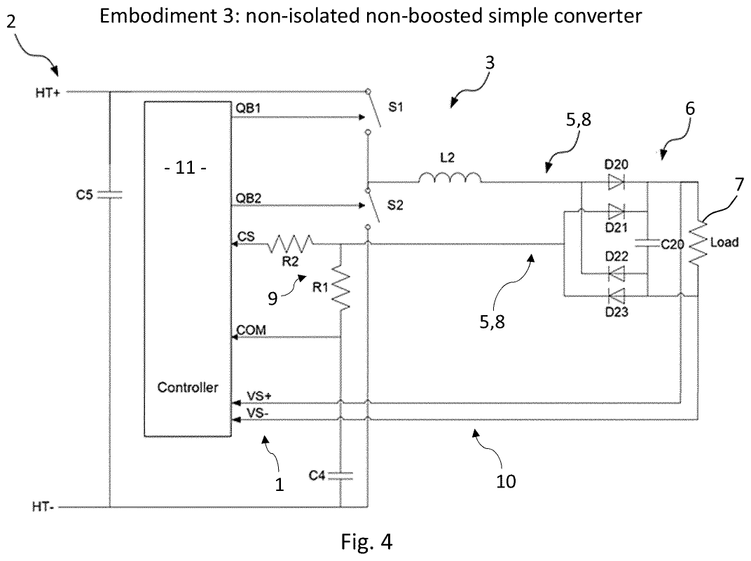

FIG. 4 is a schematic diagram of a power converter in accordance with a further embodiment of the present invention;

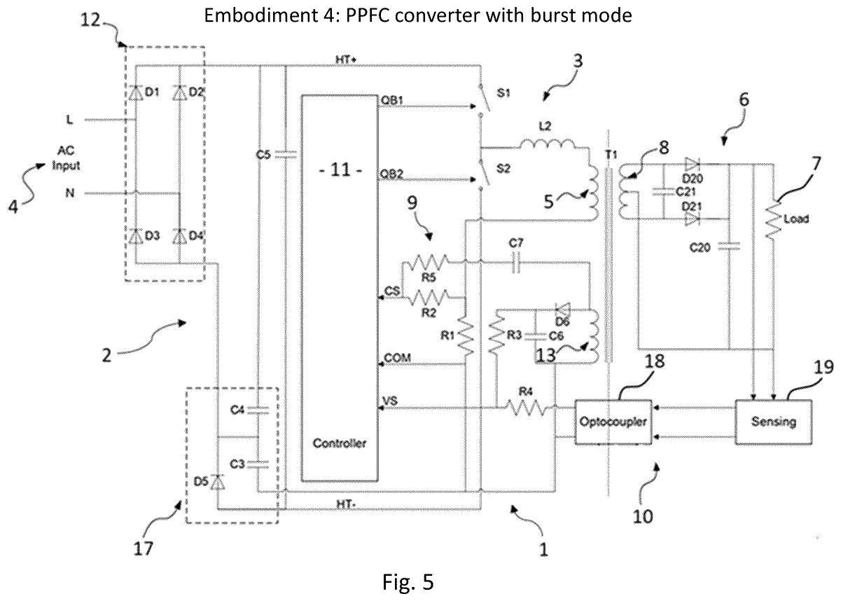

FIG. 5 is a schematic diagram of a power converter in accordance with a further embodiment of the present invention;

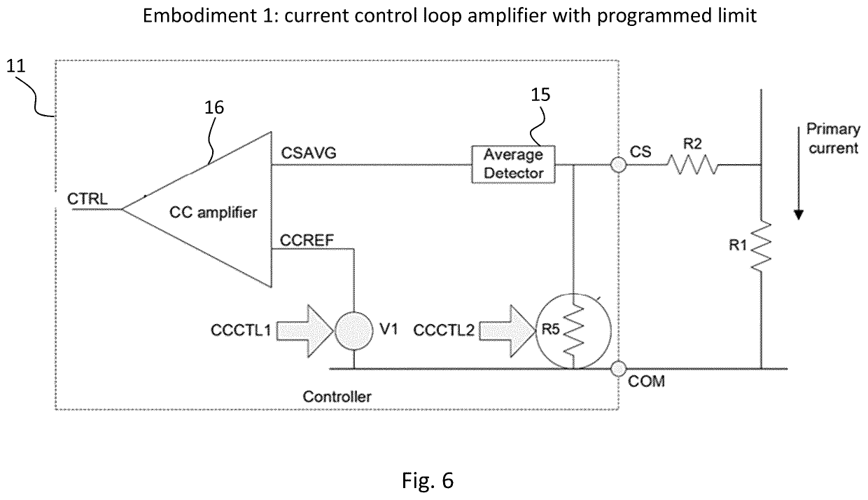

FIG. 6 is a schematic diagram of a current sensing circuit in accordance with an embodiment of the present invention;

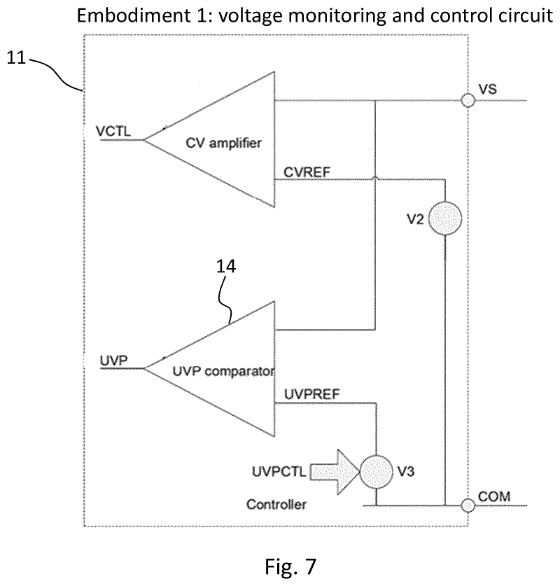

FIG. 7 is a schematic diagram of a voltage sensing circuit in accordance with an embodiment of the present invention;

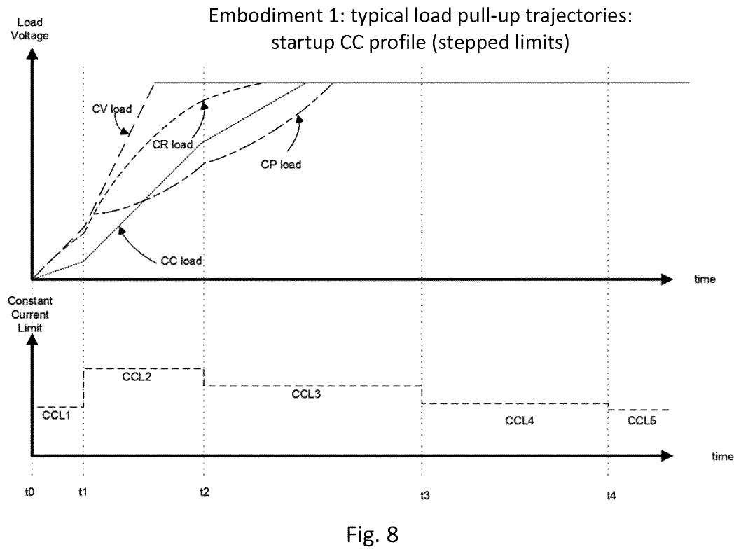

FIG. 8 is a graph showing a startup current profile using stepped limits in accordance with an embodiment of the present invention;

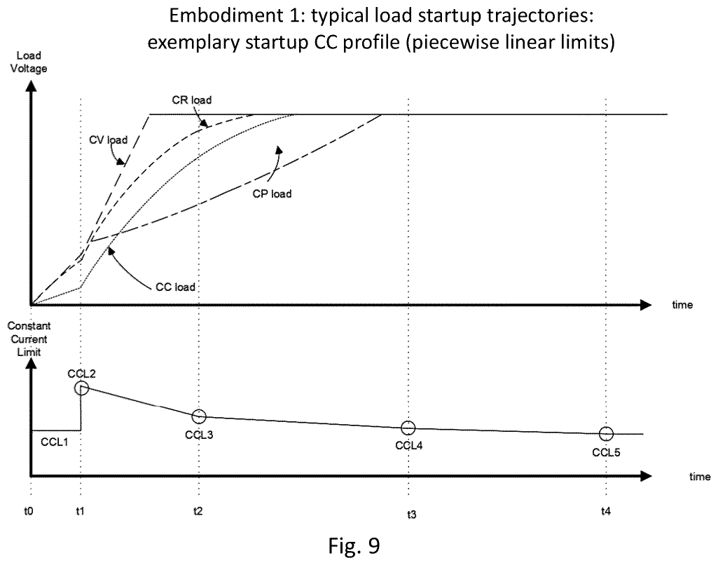

FIG. 9 is a graph showing a startup current profile using piecewise linear limits in accordance with an embodiment of the present invention;

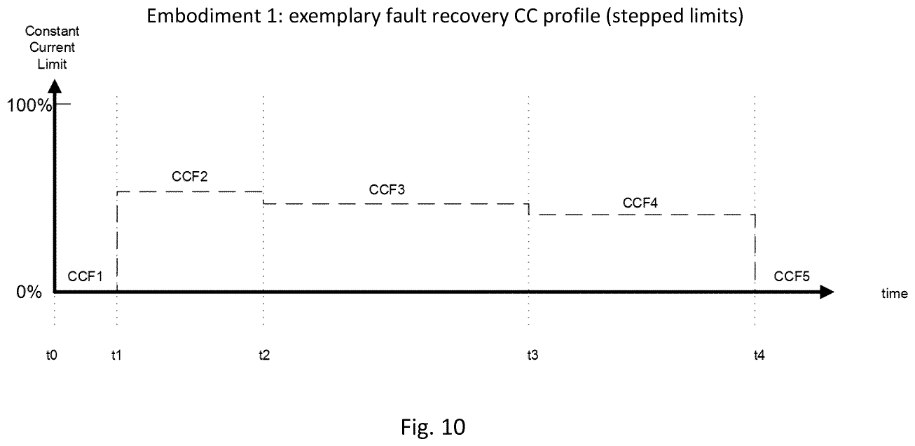

FIG. 10 is a graph showing a fault recovery current profile in accordance with an embodiment of the present invention;

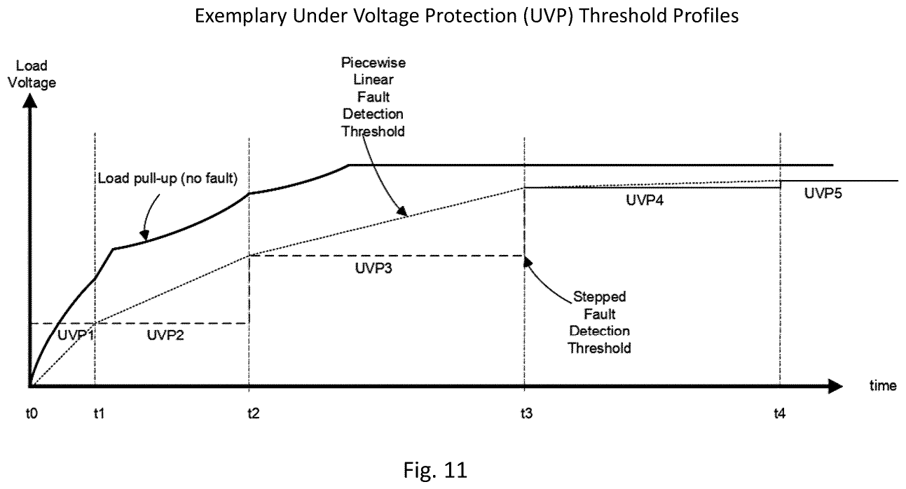

FIG. 11 is a graph showing an under-voltage protection threshold profile in accordance with an embodiment of the present invention;

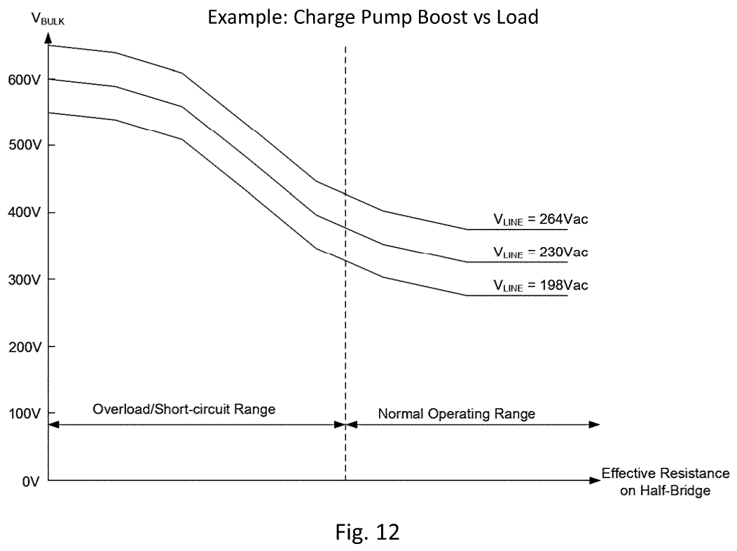

FIG. 12 is a graph showing typical relationships between the charge pump boost voltage and the load;

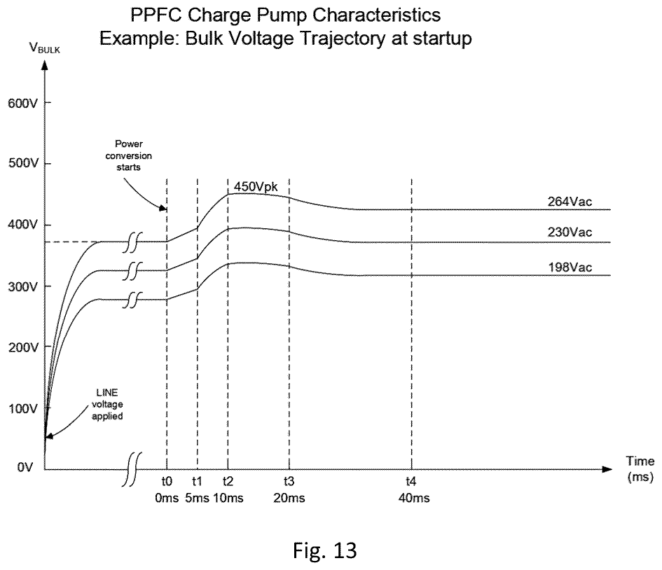

FIG. 13 is a graph showing typical bulk voltage trajectories at startup in accordance with an embodiment of the present invention;

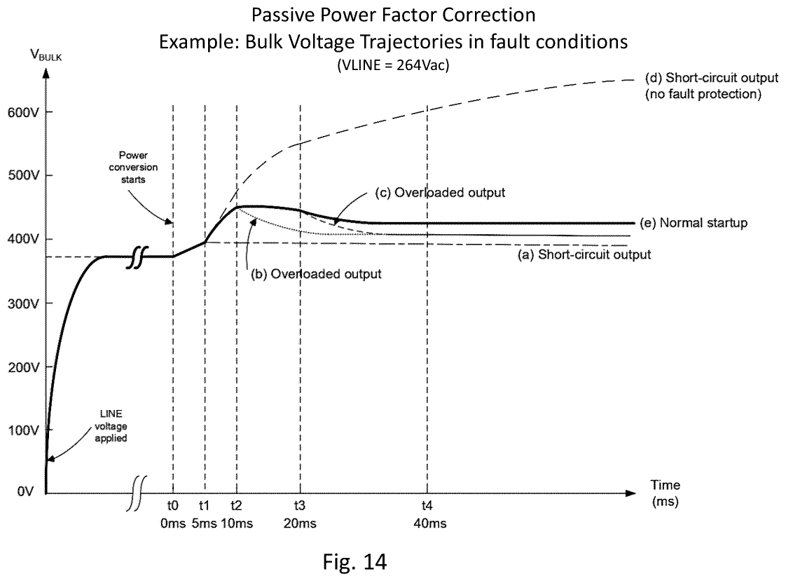

FIG. 14 is a graph showing typical bulk voltage trajectories in fault conditions at startup in accordance with an embodiment of the present invention;

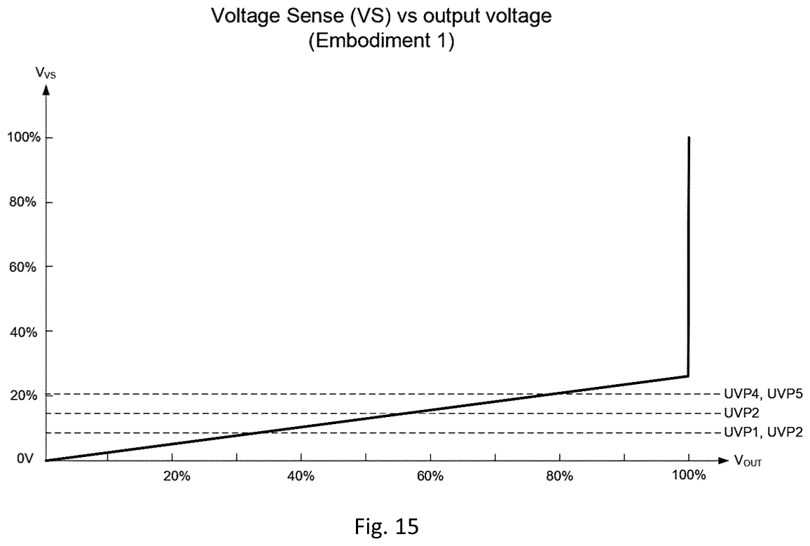

FIG. 15 is a graph showing the relationship between the voltage sense signal (VS) and the output voltage in accordance with an embodiment of the present invention; and

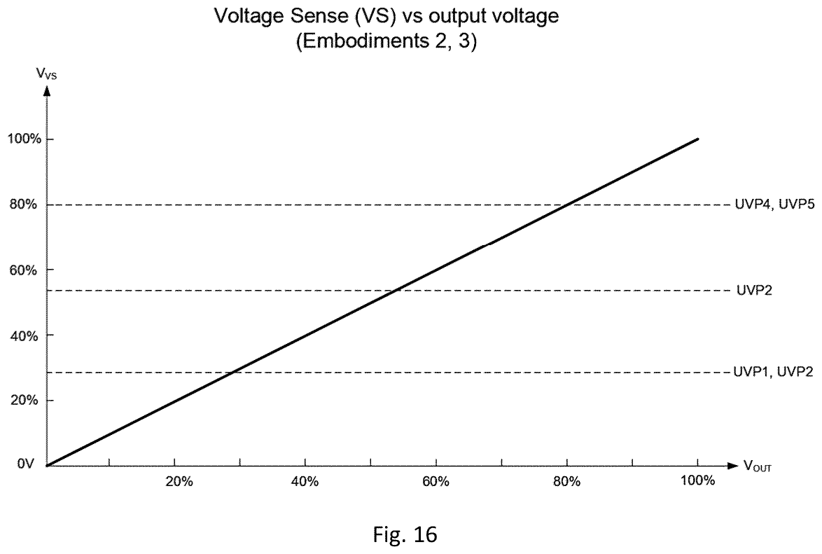

FIG. 16 is a graph showing the relationship between the voltage sense signal (VS) and the output voltage in accordance with another embodiment of the present invention.

For completeness, any reference numerals, names, or other reference labels indicated in FIG. 1, which depicts prior art, do not correspond to any of the reference numerals, names, or other reference labels indicated in the remaining figures, which depict embodiments of the present invention, unless otherwise specified.

### MODE FOR THE INVENTION

### Mode for Invention

With reference to FIGS. 2 to 16, there is provided a control circuit 1 for a power converter 2. The power converter comprises a primary circuit 3 for receiving a supply power 4, with the primary circuit having a primary connection 5. A secondary circuit 6 provides a load power to a load 7. The secondary circuit 6 has a secondary connection 8 connected to the primary connection 5. There is a current sensing circuit 9 for detecting a current sense signal CS derived from an output current, and a voltage sensing circuit 10 for detecting a voltage sense signal VS derived from an output voltage.

The control circuit 1 comprises a controller 11 for controlling one or more switches (S1, S2) in the primary circuit 3 to control the output current and/or the output voltage in accordance with one or more control profiles and based on the current sense signal CS and/or the voltage sense signal VS.

One of the control profiles is a startup current profile. One embodiment is a startup CC profile as shown in FIG. 8.

The startup current profile comprises a target output current having an initial startup value and a final startup value lower than the initial startup value. In FIG. 8, the target output current is shown as the Constant Current Limit. The initial startup value is shown as CCL1, and the final startup value is shown as CCL5.

The target output current increases to a maximum startup value higher than the initial startup value and then decreases from the maximum startup value to the final startup value. In FIG. 8, the maximum startup value is shown as CCL2 and there are two further intermediate startup values CCL3 and CCL4 each lower than the previous before the lowest and final startup value CCL5.

The startup current profile comprises one or more time periods, with the target output current in each time period being one or more of: a constant value; a linearly varying value; and a continuously varying value. In FIG. 8, the target output current in each time period (t0-t1 for CCL1, t1-t2 for CCL2, t2-t3 for CCL3, t3-t4 for CCL4, t4-t5 for CCL5) is a constant value. In FIG. 9, the target output current in the first time period (t0-t1 for CCL1) is a constant value. The target output current in each of the remaining time periods (t1-t2 for CCL2, t2-t3 for CCL3, t3-t4 for CCL4, t4-t5 for CCL5) is a linearly decreasing value, with each decreasing at a slower rate than the previous. It will be appreciated however that these are merely specific examples and that there are many alternative ways of defining the startup current profile depending on the application.

The final startup value is typically equal to a maximum expected load current. This can also be referred to as the intended rated current of the application CCRATED.

The controller 11 utilizes the startup current profile during a startup phase of the power converter 2.

One of the control profiles is an under-voltage protection (UVP) threshold profile. One embodiment is the profile shown in FIG. 11.

The under-voltage protection threshold profile comprises a threshold load voltage having an initial threshold value and a final threshold value higher than the initial threshold value. In FIG. 11, the initial threshold value is shown as UVP1, and the final threshold value is shown as UVP5.

The under-voltage protection threshold profile comprises one or more time periods, the threshold load voltage in each time period being one or more of: a constant value; a linearly varying value; and a continuously varying value. In FIG. 11, the threshold load voltage shown in dashed line in each time period (t0-t1 for UVP1, t1-t2 for UVP2, t2-t3 for UVP3, t3-t4 for UVP4, t4-t5 for UVP5) is a constant value. The threshold load voltage shown in dotted line in each time period (t0-t1 for UVP1, t1-t2 for UVP2, t2-t3 for UVP3, t3-t4 for UVP4, t4-t5 for UVP5) is a linearly increasing value, with each increasing at a slower rate than the previous. It will be appreciated however that these are merely specific examples and that there are many alternative ways of defining the under-voltage protection threshold profile depending on the application.

The controller 11 shuts down the power converter 2 when the voltage sense signal VS is less than the threshold load voltage.

One of the control profiles is a fault recovery current profile. One embodiment is a fault recovery CC profile as shown in FIG. 10.

The fault recovery current profile comprises a target output current having a maximum recovery value and a final recovery value lower than the maximum recovery value. In FIG. 10, the target output current is shown as the Constant Current Limit. The maximum recovery value is shown as CCF2, and the final recovery value is shown as CCF5.

The target output current starts at substantially zero before reaching the maximum recovery value. In FIG. 10, the target output current starts at zero and is shown as CCF1. The final recovery value is substantially zero, shown as CCF5 and zero in FIG. 10. The maximum recovery value is less than a maximum expected load current, which can also be referred to as the intended rated current of the application CCRATED.

The fault recovery current profile comprises one or more time periods, the target output current in each time period being one or more of: a constant value; a linearly varying value; and a continuously varying value. In FIG. 10, the target output current in each time period (t0-t1 for CCF1, t1-t2 for CCF2, t2-t3 for CCF3, t3-t4 for CCF4, t4-t5 for CCF5) is a constant value. It will be appreciated however that these are merely specific examples and that there are many alternative ways of defining the fault recovery current profile depending on the application.

The controller 11 utilizes the fault recovery current profile after the controller detects a fault or has shut down the power converter 2 when the voltage sense signal VS is less than a threshold load voltage.

In the embodiments shown, the power converter 2 has a resonant circuit. Resonant converters are particularly suitable for delivering a higher output current when compared to flyback converters. Transformers and inductors in the resonant converter are typically designed for low flux density to keep the core losses low as they use all four quadrants of the BH curve. For short periods, therefore, resonant converters can usually operate at an increased flux density and output current without additional cost. Flyback converters, however, only use one quadrant of the BH curve, which keeps losses low, but means the transformer is primarily designed for a high flux density and does not have any margin for an increased output current without additional cost. Thus, there are particular technical advantages of using the present invention with power converters comprising resonant circuits. The increased output current allowed by power converters with resonant circuits allows for startup current profiles with increased target output currents without additional components or costs.

In FIGS. 2, 3, and 5, the primary connection 5 is a primary winding of a transformer T1, and the secondary connection 8 is a secondary winding of the transformer T1 inductively coupled to the primary winding.

In FIG. 4, a wired connection directly connects the primary connection 5 to the secondary connection 8.

In the embodiments shown, the power converter 2 comprises a passive power factor correction (PPFC) circuit.

The current sensing circuit 9 comprises a variable pull-down resistor. The voltage sensing circuit 10 comprises a voltage comparator with a voltage threshold profile. The voltage sense signal VS comprises a primary voltage sense signal and a secondary voltage sense signal.

In FIGS. 2, 3, and 5, which are all isolated power converters, the output current is a current provided by an output of the primary circuit.

In FIG. 4, which is a non-isolated power converter, the output current is a load current provided to the load.

The output voltage is typically a load voltage provided to the load.

The load can comprise at least one light emitting diode. In other embodiments, the load comprises at least one DC to DC converter.

It will be appreciated that the present invention provides a control circuit 1 as described above. This can be just the controller 11 in the form of an integrated circuit (IC) or chip. Alternatively, the invention can be in the form of a control circuit of which the controller 11 is part. In another aspect, the present invention provides a power converter 2 having a control circuit 1 in any of the embodiments as described above.

The present invention is particularly suited to driving LED lighting apparatuses and as such another aspect of the present invention provides a LED lighting apparatus having a control circuit 1 or power converter 11 as described above.

It will be appreciated from the above that the present invention also provides a method of controlling a power converter. In a basic embodiment, the power converter comprises a primary circuit 3 for receiving a supply power 4, with the primary circuit having a primary connection 5. A secondary circuit 6 provides a load power to a load 7. The secondary circuit 6 has a secondary connection 8 connected to the primary connection 5.

In this basic embodiment, the method comprises detecting a current sense signal CS derived from an output current, detecting a voltage sense signal VS derived from an output voltage, and controlling one or more switches (S1, S2) in the primary circuit 3 to control the output current and/or the output voltage in accordance with one or more control profiles and based on the current sense signal CS and/or the voltage sense signal VS.

Referring to FIGS. 2 to 5 in further detail, there is provided a power converter 2 for delivering regulated voltage and current to an output load 7. The power converter 2 has a primary circuit 3 for receiving a supply current from line input 4 (supply power) and a secondary circuit 6 for delivering load power to the load 7. Current received from line input 4 is rectified by rectifier circuit 12. FIGS. 2, 3, and 5 include the PPFC components C3, C4, and D5 that draw current from rectifier 12 and feed it to the bulk storage capacitor C5. Current taken from one terminal of capacitor C5 is inverted by switches S1 and S2 which are controlled by controller 11 and received by inductor L2 and delivered to the primary winding 5 and current sensor R1 whence it is returned to a second terminal of capacitor C5. Primary winding 5 is magnetically coupled to secondary winding 8. The secondary winding 8 is connected through one or more rectifiers D20, D21 to an output capacitor C20 which is connected across the load 7. In FIGS. 2, 3, and 5, the voltage sense signal VS is provided to the controller 11 from the auxiliary winding 13 for regulating the output voltage. In FIG. 4, the voltage sense signal is shown as a differential, where VS+ is equivalent to VS and VS− is equivalent to COM in FIG. 2. The voltage sense signal VS is linearly scaled to the output voltage by the turns ratio of transformer windings 8 and 13. The current sense signal CS is provided to the controller 11 through resistor R2 from the current sensing element R1 for regulating the output current. The current sense CS signal is also linearly scaled to the output current by the turns ratio of transformer windings 8 and 5.

When starting the power converter 2 to pull up and drive the load 7, the controller 11 monitors the current sense signal CS to apply a constant current limit (target output current) which varies with time, following the predetermined startup CC profile. This profile permits higher output current during an initial startup period, reducing to a lower final value after the initial startup period is completed.

Referring to FIG. 7, which depicts part of the controller 11, the controller 11 compares the voltage sense signal VS against an under-voltage protection reference threshold UVPREF (threshold load voltage) which varies with time, following a predetermined under-voltage protection (UVP) threshold profile in order to detect the presence of load fault conditions. If a load fault condition is detected, the controller 11 will change the CC limit (target output current) from the startup current profile to a fault recovery current profile. The fault recovery current profile also varies with time, ultimately reducing the CC limit (target output current) to zero so that the power converter is forced to stop power conversion. In a PPFC power converter, the voltage sense signal VS can also be derived from the HT bus. When the power converter 2 is overloaded and the HT bus voltage is boosted to a dangerous level, the comparator 14 can sense an over-voltage situation is going to occur so that a fault is detected and the fault recovery current profile is implemented. The comparator 14 can sense an over-voltage is about to occur by sensing an under-voltage in the output voltage.

Referring to FIG. 6, which depicts part of the controller 11 among other features, the current sense signal CS is received from the current sense resistor R1 via padding resistor R2 and pull-down resistor R5. The AC content of the current sense signal CS is rectified and converted to an average value by average detector 15, producing a CSAVG signal. A CCREF signal provides a reference signal to amplifier 16. The amplifier 16 amplifies the differences between the signals CSAVG, CCREF producing an output signal CTRL which is used to close the current regulation control loop.

In the embodiment shown in FIG. 2, a charge pump 17 uses the switched primary current to boost the voltage on bulk capacitor C5, providing a means of passive power factor correction. An optocoupler 18 receives a feedback signal from a voltage sensing block 19 located on the secondary circuit 6 and communicates this as a voltage sense signal VS to the controller 11 via resistor R3. Alternatively, the signal received from the voltage sensing circuit can be transmitted to the primary circuit 3 from the secondary circuit 6 using inductive coupling with a signal transformer or capacitive coupling. Information from the auxiliary supply rail AUX is combined via resistor R4 so that the voltage sense signal VS contains both primary and secondary feedback information. A possible relationship between the voltage sense signal VS and the output voltage (Vout) is shown in FIG. 15. The relationship has two portions: in the range VS<25%, the gain is approximately 0.3, this being set by the transformer turns ratio and the values of R3 and R4. In the portion VS>25%, the gain is very large, being controlled by the secondary voltage sensing circuit which preferably includes an in-tegrating amplifier.

Assuming that the power converter 2 starts up with no fault conditions present, controller 11 applies the startup CC profile shown in FIG. 8. The CC limit (target output current) is sequentially stepped from CCL1 through CCL5 in periods delimited by timing marks t0 through to t4. The load voltage climbs in response to the delivered power, following a trajectory which depends upon the nature of the load 7 itself. Trajectories are shown in FIG. 8 for load types CC, CV, CR, and CP. FIG. 8 shows five current steps, but it is possible to have a different number of steps as well as for the steps to vary over time.

It is assumed herein that CP loads are inactive until the load voltage exceeds a certain turn-on voltage threshold. Therefore, the maximum current that may be drawn by a CP load, CCMAX is calculated to be CCMAX=CCRATED*VREG/VCPON, where:
CCRATED is the intended rated current of the application;
VREG is the target regulated output voltage; and
VCPON is the minimum voltage at which the CP load becomes active.

For most practical applications VCPON>30% * VREG.

The startup CC profile is shaped so as to give the best opportunity to take protective action as early as possible in response to detected load faults. FIG. 6, which depicts part of the controller 11 among other features, shows two complementary means to provide the stepped CC limit (target output current) in the current control loop. CC amplifier 16 produces a control signal CTRL that is used to limit the output current, by amplifying the difference between the sensed current, represented by CS, and a reference CCREF. A signal CCCTL2 provides a control signal to the variable resistor R5 which, together with R2, sets the scaling of the primary current to the current sense signal CS. This method permits large changes in CC limit to be configured by the value of R2. A second signal CCCTL1 controls the voltage reference V1, setting the level CCREF, which provides the reference for the current control loop. This method permits changes to be made to the CC limit which is independent of the value of R2. The combination of both methods provides both design flexibility and performance advantage.

Referring to FIG. 11, the UVP threshold (threshold load voltage) is stepped from UVP1 through UVP5, in periods delimited by timing marks t0 through to t4. This can be implemented by multiple comparators or by a single comparator with a one switched input. FIG. 7 shows an implementation using a single comparator 14 with a switched input, where the signal UVPCTL controls the voltage reference V3 to produce the switched input UVPREF.

Referring again to FIG. 8, in the period t0-t1, the CC level is set to a level CCL1, which is set to be greater than the maximum expected final load current, CCRATED. If the output has a short-circuit fault, the controller detects that VS<UVP1 at the end of the period and shuts down the power converter immediately, minimizing the overboosting.

In the period t1-t2, assuming that no fault was detected in the previous period, the CC level is set to a level CCL2, where CCL2 will preferably be 120-300% of CCMAX. In the same period, the UVP threshold is set to a level UVP2 where UVP≤VCPON. If the current drawn by the load exceeds CCL2, the output voltage falls until VS<UVP2 and a fault is detected. If this occurs, the CC limit is switched from the startup current profile to the fault recovery current profile, as shown in FIG. 10, so that the CC level is changed to CCF2, where CCF2<CCRATED.

In the period t2-t3, assuming that no fault was detected in the previous periods, the startup current profile is still applied and the CC level is set to a level CCL3, where preferably, CCL2≥CCL3≥CCL4 as shown in FIG. 8. In the same period, the UVP threshold is set to a level UVP3 where UVP2≤UVP3≤UVP4. If no fault condition exists, then throughout the period VS>UVP3. However, if the output load current exceeds CCL3 then VS falls below UVP3 and the CC profile is switched from the startup current profile to the fault recovery current profile and the CC level is changed to CCF3.

In the period t3-t4, assuming that no fault was detected in the previous periods, the startup current profile is still applied and the CC level is set to a level CCL4, where CCL4≥CCRATED. In the same period, the UVP threshold is set to a level UVP4 where UVP4<VREG. If no fault condition exists, then throughout the period VS>UVP4. However, if the output load current exceeds CCL4 then VS falls below UVP4 and the CC profile is switched from the startup current profile to the fault recovery current profile and the CC level is changed to CCF4.

In the period t4-t5, assuming that no fault was detected in the previous periods, the startup profile is still applied and the CC level is set to a level CCL5, where CCL5=CCRATED. In the same period, the UVP threshold is set to a level UVP5 where UVP5<VREG. If no fault condition exists, then throughout the period VS>UVP5. However, if an overload fault is present, the output load current exceeds CCL5 and the output voltage falls, until VS<UVP5. At this point, the fault is detected and the CC profile is switched from startup current profile to the fault recovery current profile and the CC level is changed to CCF5.

If a fault is detected at any time after t1, the controller switches to the fault recovery current profile, as shown in FIG. 10. Preferably CCF1, CCF2, CCF3, and CCF4 are less than CCRATED and CCF5 is substantially zero. The fault recovery current profile significantly reduces the primary current and thereby also the charging current produced by charge pump 17. This allows any excess charge in the bulk capacitor C5 to be delivered to the output load 7, reducing the voltage on C5 and protecting it fro-moverboosting.

Referring to FIG. 14, plotted waveform 14a shows how the boosted bulk supply voltage is reduced after an overload fault is detected in each of the periods t1-t2 (plot 14a), t2-t3 (plot 14b), t3-t4 (plot 14c). For comparison, plot 14d shows the bulk supply voltage trajectory in the overload condition if the converter continues to run without protective action being taken. For reference, plot 14e shows the bulk supply voltage trajectory during a normal startup at maximum line voltage.

Referring to FIG. 8, it will be appreciated that there are many alternative ways of defining the startup current profile, the fault recovery current profile and the UVP threshold profile. For example, the number of discrete steps may be varied; the shape of the profile may be varied; the discrete steps may be replaced by linear piecewise segments, as shown in FIG. 9, or else by a time-continuous curve.

A second embodiment, intended for lower cost products, is shown in FIG. 3, which differs from the first embodiment in FIG. 2 in the following aspects. There is no secondary voltage sensing circuit, so that the VS signal is derived entirely from winding 13 and in its simplest form. The relationship between VS and the output voltage is given in FIG. 16, together with under-voltage protection thresholds UVP1-UPV5 shown for illustrative purposes.

A third embodiment intended for even lower cost products shown in FIG. 4, in which the transformer T1 has been removed. The supply to the input is DC so that no rectifier block is required. In this case, there is neither voltage transformation nor galvanic isolation between the primary and secondary circuits. In its simplest form, passive power factor correction is also not used.

In a fourth embodiment shown in FIG. 5, there is provided a converter with a burst mode for maintaining control down to no-load. The controller 11 saves power and increases conversion efficiency by entering standby when the primary current falls below a predetermined threshold. The controller 11 implements burst control by sensing peak-peak amplitude or a rectified average of the reflected load current seen on the CS pin.

In order to increase the addressable range of line and load combinations, it can be helpful to add parallel capacitance to the basic LC converter, C21, thus implementing the LCC or LLCC topology. In these applications, the resulting error in the primary regulated current loop may be corrected by adding a cancellation circuit, as described by PCT/CN2016/070166. FIG. 5 shows the use of C7 to cancel out the effect of C21. To avoid difficult capacitor values and also to reduce unnecessary power loss, R2 may be set to a non-zero value, so that the values of R2 and C7 are modified. Resistor R5 is provided to control the ringing on the CS pin, caused by leakage inductance in the transformer T1. The value of R5 directly affects the peak-peak amplitude and therefore may be used to adjust the burst threshold.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations. In particular, it is appreciated by those skilled in the art that there are different variations of the circuits described above within the scope of the present invention. There are many possible permutations of the circuit arrangements described above which are appreciated by those skilled in the art. Accordingly, the circuit components shown in the embodiments can be interchanged freely, placed in different arrangements or order, but still provide the functionality described in respect of the circuit as originally arranged or ordered in the described embodiments, and therefore, still falling within the scope of the present invention.

1. A control circuit for a power converter, the power converter comprising:
a primary circuit for receiving a supply power, the primary circuit having a primary connection;
a secondary circuit for providing a load power to a load, the secondary circuit having a secondary connection connected to the primary connection;
a current sensing circuit for detecting a current sense signal derived from an output current; and
a voltage sensing circuit for detecting a voltage sense signal derived from an output voltage;
the control circuit comprising a controller for controlling one or more switches in the primary circuit to control the output current and/or the output voltage in accordance with one or more control profiles and based on the current sense signal and/or the voltage sense signal.

2. A control circuit according to claim 1 wherein one of the control profiles is a startup current profile.

3. A control circuit according to claim 2 wherein the startup current profile comprises a target output current having an initial startup value and a final startup value lower than the initial startup value.

4. A control circuit according to claim 3 wherein the target output current increases to a maximum startup value higher than the initial startup value and then decreases from the maximum startup value to the final startup value.

5. A control circuit according to claim 3 wherein the startup current profile comprises one or more time periods, the target output current in each time period being one or more of: a constant value; a linearly varying value; and a continuously varying value.

6. A control circuit according to claim 3 wherein the final startup value is equal to a maximum expected load current.

7. A control circuit according to claim 2 wherein the controller utilizes the startup current profile during a startup phase of the power converter.

8. A control circuit according to claim 1 wherein one of the control profiles is an under-voltage protection threshold profile.

9. A control circuit according to claim 8 wherein the under-voltage protection threshold profile comprises a threshold load voltage having an initial threshold value and a final threshold value higher than the initial threshold value.

10. A control circuit according to claim 9 wherein the under-voltage protection threshold profile comprises one or more time periods, the threshold load voltage in each time period being one or more of: a constant value; a linearly varying value; and a continuously varying value.

11. A control circuit according to claim 9 wherein the controller shuts down the power converter when the voltage sense signal is less than the threshold load voltage.

12. A control circuit according to claim 1 wherein one of the control profiles is a fault recovery current profile.

13. A control circuit according to claim 12 wherein the fault recovery current profile comprises a target output current having a maximum recovery value and a final recovery value lower than the maximum recovery value.

14. A control circuit according to claim 13 wherein the target output current starts at substantially zero before reaching the maximum recovery value.

15. A control circuit according to claim 13 wherein the fault recovery current profile comprises one or more time periods, the target output current in each time period being one or more of: a constant value; a linearly varying value; and a continuously varying value.

16. A control circuit according to claim 13 wherein the final recovery value is substantially zero, or the maximum recovery value is less than a maximum expected load current, or both.

17.-33. (canceled)

34. A control circuit according to claim 12 wherein the controller utilizes the fault recovery current profile after the controller detects a fault or has shut down the power converter when the voltage sense signal is less than a threshold load voltage.

35. A control circuit according to claim 1 wherein the power converter comprises a passive power factor correction circuit.

36. A power converter having a control circuit according to claim 1.

37. A method of controlling a power converter, the power converter comprising:
a primary circuit for receiving a supply power, the primary circuit having a primary connection; and
a secondary circuit for providing a load power to a load, the secondary circuit having a secondary connection connected to the primary connection;
the method comprising:
detecting a current sense signal derived from an output current;
detecting a voltage sense signal derived from an output voltage; and
controlling one or more switches in the primary circuit to control the output current and/or the output voltage in accordance with one or more control profiles and based on the current sense signal and/or the voltage sense signal.
